(19) United States
(12) Patent Application Publication
(10) Pub. No.: US 2026/0092573 A1
(43) Pub. Date: Apr. 2, 2026

(54) ENGINE WATER JACKET FORMED FROM A UNIITARY BILLET AND METHOD FOR MANUFACTURE THEREOF

(71) Applicant: KATECH ENGINEERING, LLC, Clinton Township, MI (US)

(72) Inventor: Eric Suits, Clinton Township, MI (US)

(73) Assignee: KATECH ENGINEERING, LLC, Clinton Township, MI (US)

(21) Appl. No.: 18/903,344

(22) Filed: Oct. 1, 2024

(51) Int. Cl. F02F 1/14

(52) U.S. Cl. CPC F02F 1/14

(57) ABSTRACT

An internal combustion engine block includes a cylinder block formed of a billet and defining at least one cylinder bore that terminate at a block deck surface, with a majority of the outer circumference of the at least one cylinder bore being surrounded by a cylinder wall. A water jacket channel is defined within the cylinder block at an upper end of the plurality of cylinder bores adjacent to the block deck surface. The water jacket channel is positioned external to the cylinder wall and surrounding a majority of an outer circumference of the at least one cylinder bore. A plurality of bridges span a width of the water jacket channel to connect to the cylinder wall and the cylinder block at the block deck surface. The engine block is formed by machining the billet with a computer numerical control machine with one to five axes or by additive manufacturing.

### FIELD OF THE INVENTION

The present invention relates to internal combustion engines, and more particularly to water jacketed internal combustion engines formed from a unitary billet.

### BACKGROUND OF THE INVENTION

Conventional engine blocks are typically cast from sand or die molds in segments with cavities formed therein. Once the mold is formed, the mold cavity is filled with molten metal and allowed to cool. Cast engine blocks typically require post mold machining to achieve required dimensions and finishes. Defects and irregularities are common for various reasons including blowholes, shrinkage of the cavity, misalignment of mold segments, and metal penetration within the mold. Engine blocks are usually made of grey cast iron or aluminum alloys. Both materials offer good fluidity in a molten state for casting and thermal conductivity to resist damage due to thermal shocks. Where cast iron is popular for its strength and less production cost, aluminum alloys can significantly cut down the weight by up to 50%.

Conventionally engine blocks are provided with a cooling device called a water jacket configured to cool an engine by flowing coolant into of the interior portions of an engine to absorb heat and thereby moderate the operating temperature of the engine. Without such a cooling device, the engine block or its cover can overheat and crack. Repair of a cracked engine block is expensive and often not even possible.

When seeking greater engine performance from a vehicle, operating at high temperatures and pressures is often desirable. To achieve the higher operational temperatures and pressures, engines are being manufactured from different materials that are better able to withstand higher temperatures and pressures without cracking. Some engine blocks are now being manufactured from a large block of high-grade aluminum that is machined to form a unitary engine block. These are synonymously referred to in the field as billet engines or billet blocks. A benefit of a billet block is that while 6061 aluminum has similar tensile strength to cast iron, the yield is 10 percent, meaning it can move 10 percent of its length or thickness before it will crack, compared to cast iron that typically has a yield of from 1 to 1.5 percent. Additionally, if cast iron cracks, it cannot be repaired, while an aluminum billet block is amenable to being welded.

Another factor that influences the performance and power handling ability of an engine is the deck of the engine block. The “deck” is a term conventional to the art for the block surface that is machined flat to receive the head gasket and cylinder head and form a seal therewith. The three main types of decks are Open-Deck, Semi-Closed Deck, and Closed-Deck blocks. “Open”, “Closed” and “Semi-Closed” refer to support space between the cylinder wall and the block. Open-deck blocks are the least desirable from a performance standpoint and the weakest variation. “Open” refers to the space between the cylinder wall and the block itself being open. Semi-Closed deck blocks offer reasonable strength and an open coolant passage to the cylinder head for optimal cooling. “Semi-closed” is similar to an open deck block, with the addition of extra bridges to support the cylinder wall against expansion and cracking. Regular semi-closed deck blocks are typically reliable for 4-500 horse power (HP) (300-370 kW) engines. “Closed” refers to this space being essentially closed in, apart from the holes that allow coolant to flow to the cylinder heads. This provides the best strength and support for cylinders when used in high horsepower applications.

While billet engine blocks, water jackets, and semi-closed or closed decks each can be used to enhance engine performance, manufacturing limitations have thus far not allowed these three performance enhancements to be used simultaneously.

Thus, in the pursuit of further enhancing engine performance there exists a need for a water jacketed internal combustion engine block formed from a unitary billet with a semi-closed or closed deck.

### SUMMARY OF THE INVENTION

The present invention provides an internal combustion engine block that includes a cylinder block formed of a billet and defining at least one cylinder bore that terminates at a block deck surface, with a majority of the outer circumference of the at least one cylinder bore being surrounded by a cylinder wall. A water jacket channel is defined within the cylinder block at an upper end of the at least one cylinder bore adjacent to the block deck surface. The water jacket channel is positioned external to the cylinder wall and surrounding a majority of an outer circumference of the at least one cylinder bore. One or more bridgespan, a width of the water jacket channel to connect to the cylinder wall and the cylinder block at the block deck surface. The engine block is formed by machining the unitary billet with a computer numerical control (CNC) machine with one to five axes or by additive manufacturing.

### BRIEF DESCRIPTION OF THE DRAWINGS

The present invention is further detailed with respect to the following figures that depict various aspects of the present invention.

FIG. 1 is a perspective view of an engine block according to embodiments of the present invention;

FIG. 2 is a top view of the engine block of FIG. 1; and

FIG. 3 is a section view of the engine block of FIGS. 1 and 2 taken along like 3-3 in FIG. 2.

### DESCRIPTION OF THE INVENTION

The present invention has utility as a water jacketed internal combustion engine block formed from a unitary billet with a semi-closed or closed deck.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein a “billet” refers to a solid and unitary piece of material; the material being a plastic or a metal.

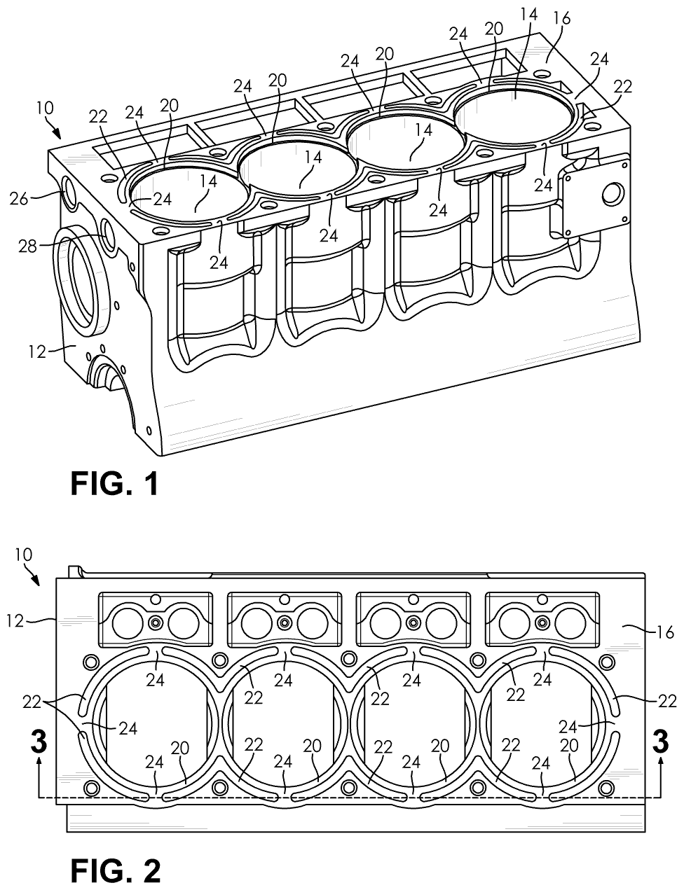

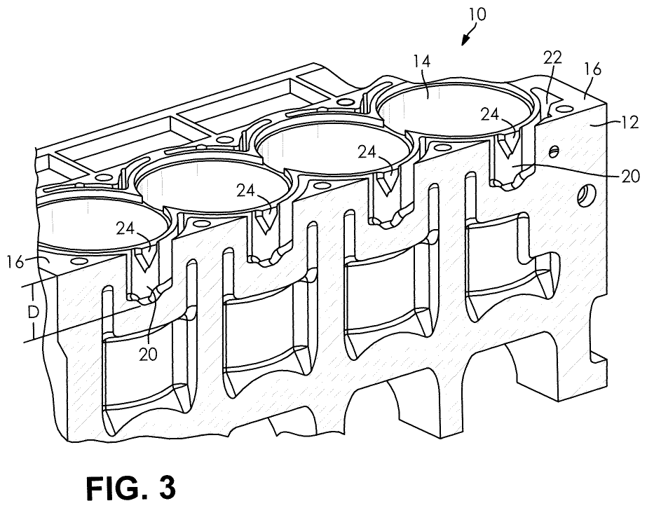

While the present invention is detailed pictorially hereafter with respect to a multiple cylinder engine, it is appreciated that the present invention is equally applicable to a single cylinder engine. Referring now to the figures, an inventive internal combustion engine block 10 includes a cylinder block 12 formed of a unitary billet. The cylinder block 12 defines, among other features, a plurality of cylinder bores 14 that are each configured to receive a piston head of an internal combustion engine. Each of the cylinder bores 14 has a diameter that is between 0.25″-40″ and a total height of 0.25″-40″, as measured from a block deck surface 16 of the cylinder block 12. Each of the cylinder bores 14 terminates at the block deck surface 16. The block deck surface is a planar surface that is configured to receive a head gasket and a valve cover of the engine. The cylinder block 12 forms a cylinder wall 20 that surrounds a majority of the outer circumference of the plurality of cylinder bores 14. As shown in the figures, some inventive embodiments of the inventive engine block include at least four cylinder bores 14. According to some inventive embodiments, the plurality of cylinder bores 14 are arranged in series. According to other inventive embodiments, the plurality of cylinder bores are fluidly connected, for example at an upper end thereof adjacent to the block deck surface 16, as shown in FIGS. 1 and 3.

The cylinder block 12 additionally defines a water jacket channel 22 at an upper end of the plurality of cylinder bores 18 adjacent to the block deck surface 16. As shown in FIGS. 1-3, the water jacket channel 22 is positioned external to the cylinder wall 20 and surrounds a majority of an outer circumference of the plurality of cylinder bores 18. According to certain inventive embodiments, the cylinder wall has a thickness of 0.025″-10″ between each of the cylinder bores 14 and the water jacket channel 22. Advantageously, there are no seams or welds within the water jacket channel 22 or between the water jacket channel 22 and the cylinder bores 14, thereby reducing the likelihood of cracks within the water jacket channel 22 and leaks of the cooling fluid. According to other inventive embodiments, the water jacket channel 22 is adapted to circulate a fluid such as water of vehicle coolant therein in order to absorb heat generated within the cylinder bores 14 and to transport that absorbed heat to a cooling system of the vehicle, for example to a radiator of the vehicle. As shown in FIG. 3, the water jacket channel 22 has a depth D that extends from the block deck surface 16 to the bottom most part of the water jacket channel 22. According to still other inventive embodiments, depth D of the water jacket channel 22 extends along between 5 to 50 percent of a total height of the plurality of cylinder bores 14.

The cylinder block 12 additionally defines a plurality of bridges 24 that span a width of the water jacket channel 22 and connect to the cylinder wall 20 and the cylinder block 12 at the block deck surface 16. As such, the block deck surface is not an open deck type, but instead is either a semi-closed or closed deck type, thereby providing enhanced support to the cylinder wall 20 so that the engine block 10 is configured for enhanced performance given its tolerance of high temperatures and high pressures. According to certain inventive embodiments, there are at least two bridges 24 for each of the cylinder bores 14 defined within the cylinder block 12. According to other inventive embodiments, the plurality of bridges 24 close off or seal 5 to 95 percent of the total length of the water jacket channel 22 from the block deck surface 16. According to still other inventive embodiments, each of the plurality of bridges 24 forms a point at its bottom end thereof that extends into the water jacket channel 22, as shown in FIG. 3.

According to some certain inventive embodiments, the cylinder block 12 additionally defined a water inlet 26 that is fluidly connected to the water jacket channel 22 and that is configured to provide a cooling fluid from a cooling system of the vehicle to the water jacket channel 22. According to some inventive embodiments, the cylinder block 12 additionally defined a water outlet 28 that is fluidly connected to the water jacket channel 22 and that is configured to provide a cooling fluid from a the water jacket channel 22 back to the cooling system of the vehicle.

According to certain inventive embodiments, the inventive engine block is configured for use as part of a gas fueled engine, a diesel fueled engine, or a methanol fueled engine. According to other inventive embodiments, the inventive engine block is configured to use as part of a 2-stroke engine, a Wankel engine, or a 4-stroke engine. According to still other inventive embodiments, the inventive engine block is configured to withstand over 100 psi (lb/sq in) and 350° F.

As noted above, the cylinder block 12 of the inventive engine block is formed from a single unitary billet. Thus, the present invention avoids the typical problems associated with cast formed engine blocks. According to certain inventive embodiments, the engine block 10 is formed by machining the unitary billet with a computer numerical control (CNC) machine. According to other inventive embodiments, the CNC machine machines with at least one axis. According to still other inventive embodiments, the CNC machine machines with five axes. According to still other inventive embodiments, the inventive engine block 10 is formed by additive manufacturing, such as 3D printing. According to still other inventive embodiments, the inventive engine block 10 is formed of high-grade aluminum, such as 6061 aluminum. As used herein, “high-grade aluminum” is defined as aluminum with a purity of 99.5 to 99.99% by weight. According to still other inventive embodiments, the inventive engine block 10 is formed of a polymer, such as reinforced nylon, polybenzimidazole, polyetherimide, polyether ether ketone, polytetrafluoroethylene. polydicyclopentadiene, composites of any of the aforementioned, optionally inclusive of graphene and/or carbon fiber and/or carbon nanotube reinforcements therein.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. An internal combustion engine block comprising:
a cylinder block formed of a billet, the cylinder block defining a plurality of cylinder bores that terminate at a block deck surface, a majority of the outer circumference of each of the plurality of cylinder bores surrounded by a cylinder wall;
a water jacket channel defined within the cylinder block at an upper end of each of the plurality of cylinder bores adjacent to the block deck surface, the water jacket channel positioned external to the cylinder wall and surrounding a majority of an outer circumference of each of the plurality of cylinder bores; and
a plurality of bridges that span a width of the water jacket channel and connect to the cylinder wall and the cylinder block at the block deck surface.

2. The internal combustion engine block of claim 1 wherein the internal combustion engine block is configured for use as part of a gas fueled engine.

3. The internal combustion engine block of claim 1 wherein the internal combustion engine block is configured for use as part of a diesel fueled engine.

4. The internal combustion engine block of claim 1 wherein the internal combustion engine block is configured for use as part of a methanol fueled engine.

5. The internal combustion engine block of claim 1 wherein the internal combustion engine block is configured for use as part of a 2-stroke engine or a Wankel engine.

6. The internal combustion engine block of claim 1 wherein the internal combustion engine block is configured for use as part of a 4-stroke engine.

7. The internal combustion engine block of claim 1 wherein the the billet is a unitary billet.

8. (canceled)

9. (canceled)

10. (canceled)

11. The internal combustion engine block of claim 1 wherein the billet is formed of a high-grade aluminum.

12. The internal combustion engine block of claim 1 wherein the billet is formed of 6061 aluminum.

13. The internal combustion engine block of claim 1 wherein the billet is formed of a polymer.

14. The internal combustion engine block of claim 1 wherein the plurality of cylinder bores includes at least four cylinder bores.

15. The internal combustion engine block of claim 1 wherein the plurality of cylinder bores are arranged in series.

16. The internal combustion engine block of claim 1 wherein the plurality of cylinder bores are in fluid intercommunication.

17. The internal combustion engine block of claim 1 wherein water jacket channel has a depth that extends from the block deck surface between 5 to 50 percent of a total height of the plurality of cylinder bores.

18. The internal combustion engine block of claim 1 wherein the cylinder block additionally defines a water inlet fluidly connected to the water jacket channel.

19. The internal combustion engine block of claim 1 wherein the cylinder block additionally defines a water outlet adapted to be fluidly connected to the water jacket channel.

20. The internal combustion engine block of claim 1 wherein the plurality of bridges each form a point that extends into the water jacket channel.

21. The internal combustion engine block of claim 1 wherein there are no seams or welds within the water jacket channel.
